(19) United States
(12) Patent Application Publication
(10) Pub. No.: US 2015/0351189 A1
(43) Pub. Date: Dec. 3, 2015

(54) Controlling System for LED Lamp

(71) Applicant: Wanjong Lin, Ningbo (CN)

(72) Inventors: Xiaobo You, Ningbo (CN); Wanjiong Lin, Ningbo (CN)

(73) Assignees: SELF ELECTRONICS USA CORPORATION, Norcross, GA (US); SELF ELECTRONICS CO., LTD., Ningbo (CN)

(21) Appl. No.: 14/674,998

(22) Filed: Mar. 31, 2015

(30) Foreign Application Priority Data
May 29, 2014 (CN) 201410239833.3

(51) Int. Cl. H05B 33/08

(52) U.S. Cl. CPC H05B 33/0857; H05B 33/0845

(57) ABSTRACT

A controlling system for LED lamps includes a parameter predetermining module, a searching module, an adding module, and a system configuration module. The parameter predetermining module is configured for predetermining the controlling system to control which type of the LED chip is selected and how much the selected type of LED chip has. The searching module is configured for searching the selected type and amount of the LED chip which is controlled by the controlling system according to the parameter predetermining module. The adding module is configured for adding the searched LED chip into the controlling system. The system configuration module is configured for setting the controlling mode for the added LED chip of the adding module. The controlling system for LED lamps hide most operations which are executed in background of client and provide some simple button for user, which overcomes the professional and complicated interface of the art.

### RELATED APPLICATION

This application claims the benefit of priority to the Chinese Application, CN201410239833.3, filed on May 29, 2014, the entire specification of which is included herein by reference.

### BACKGROUND

1. Technical Field

The disclosure relates to lighting devices, and more particularly to a controlling system for LED lamp.

2. Description of the Related Art

Lamps are a very common device in our daily life, such as roadside lamps, factory lightings, and household lighting devices. Owing to different locations and purposes, lamps have various kinds of shapes, colors and fixings. As life and electronic technologies develop, various new types of LED lamps are mounted within a scene, such as house, market, etc. For example, a plurality of single-color-temperature-typed LED chips, a plurality of double-color-temperature-typed LED chips, and at least one RGB-typed LED chip are assembled into one house or one cabin. Since these LED chips have different brightness and color-temperature, it is terrible to control them via one controller or a number of controllers. In result, efficiency of the LED lamp may deteriorate. Particularly, when color-temperature or brightness need to changes in one of the rooms, it may be difficult for a user to control the LED lamp.

The above information disclosed in this section is only for enhancement of understanding of the background of the invention and therefore it may contain information that does not form the prior art that is already known in this country to a person of ordinary skill in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of a controlling system for LED lamp according to an embodiment of the present invention.

FIG. 2 is a flowchart illustrating a method of controlling LED lamps using the controlling system for LED lamp of FIG. 1

FIG. 3 is a flowchart illustrating a method of searching different type and amount of LED lamp using a searching module of the controlling system for LED lamp of FIG. 1.

FIG. 4 is a flowchart illustrating a method of controlling LED lamps using an one-key off mode of the controlling system for LED lamp of FIG. 1.

FIG. 5 is a flowchart illustrating a method of controlling LED lamps using an X %-brightness on mode of the controlling system for LED lamp of FIG. 1.

FIG. 6 is a flowchart illustrating a method of controlling LED lamps using a color-temperature scene controlling mode of the controlling system for LED lamp of FIG. 1.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

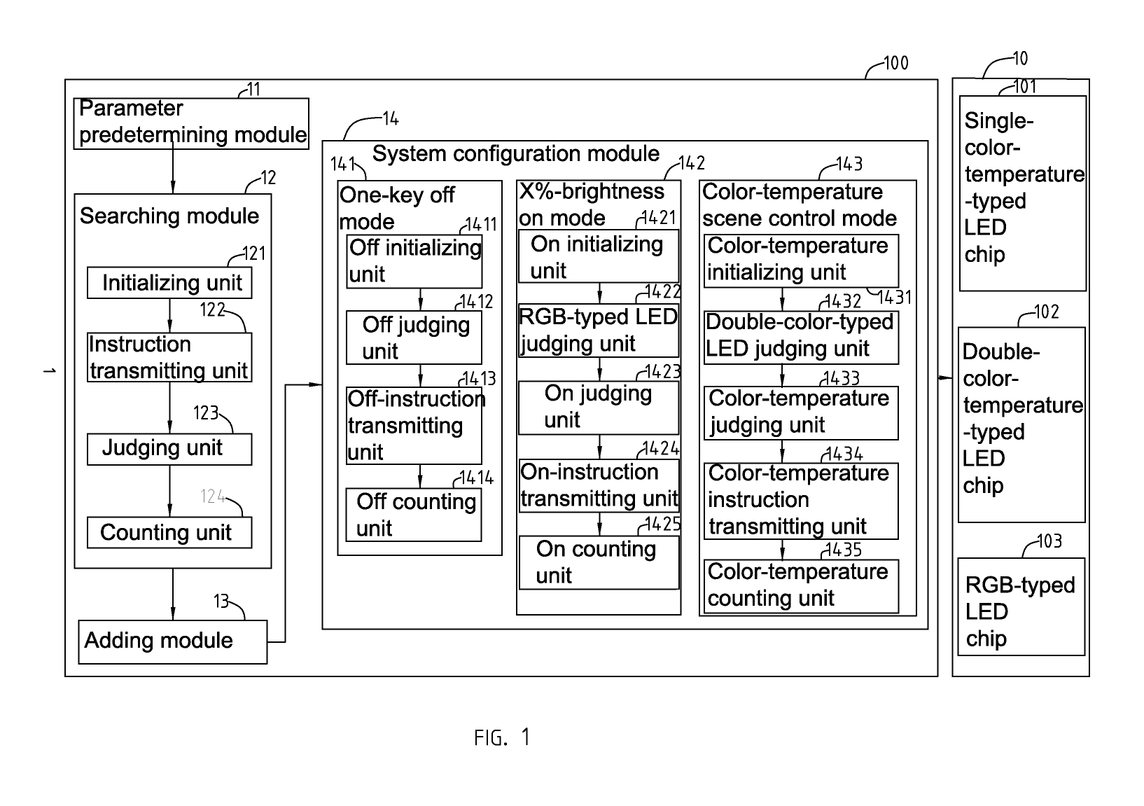

Referring to FIG. 1, a block diagram of a controlling system 100 for LED lamp is shown. The controlling system 100 is used for controlling the lighting parameter of at least one LED lamp 10, such as turning-on, turning-off, color-temperature adjustment, and so on. Turning on may be divided into a plurality of modes, such as 100%-brightness on, 50%-brightness on, 30%-brightness on, and so on, all of which is named into X %-brightness on mode. The X of the X %-brightness on mode may vary from 0 to 100. The LED lamp 10 includes at least one single-color-temperature-typed LED chip 101, at least one double-color-temperature-typed LED chip 102, and at least one RGB-typed LED chip 103. In the present embodiment, the LED lamp 10 includes the three types of the LED chips, and each of the three types of the LED chips includes five LED chips. The controlling system 100 includes a parameter predetermining module 11, a searching module 12, an adding module 13, and a system configuration module 14. They are electrically connected each other among the parameter predetermining module 11, the searching module 12, the adding module 13, and the system configuration module 14.

Each of the LED chips includes a signal generator and receiver (not shown). The signal generator and receiver is used for storing some parameter data such as address data, type code, etc. which are used to distinguish one LED chip from another and transmit some signal according to requirements from other module. Moreover, the controlling system 100 not only is electrically connected to the LED lamp but also includes other electronic components, such as CPU for deal with various kinds of data, a device for transmitting or receiving signal, and so on. In the present embodiment, the device for transmitting and receiving signal may be WIFI device or Bluetooth device. The controlling system 100 communicates with and controls the LED lamp 10 via the WIFI device or Bluetooth. The controlling system 100 can be loaded into some clients, such as mobile telephone, PAD, portable computer, and so on, and has controlling interface for communicating with user. By the controlling interface, user can control the LED lamp 10 to work according to its desire.

The parameter predetermining module 11 is assembled into the controlling system 100 and is configured for predetermining the controlling system 100 to control which type of the LED chips is selected and how much the selected type of the LED chip has. The parameter predetermining module 11 works as a user interface of a client for user to input some parameter data, such as type of the LED chip, amount of the selected LED chip, etc. In the present embodiment, the user can input the parameter data of the above three types of LED chips and the amount of each of the three types of LED chips via the parameter predetermining module 11.

The searching module 12 is configured for searching the selected types and amount of the selected LED chips which are controlled by the controlling system 100 according to the parameter predetermining module 11. The searching module 12 includes an initializing unit 121, an instruction transmitting unit 122, a judging unit 123, and a counting unit 124. The initializing unit 121 is configured for initializing the type of the LED chip which will be searched and assigning 0 to the initialized LED chip. As described above, the type of the LED chip may be single-color-temperature, double-color-temperature, or/and RGB. The instruction transmitting unit 122 is configured for transmitting lamp-type searching instruction to the LED lamp 10 which is electrically connected to the controlling system 100. The judging unit 123 is configured for comparing the answer from the LED chip with the lamp-type searching instruction and judging whether the answer of the LED chip is meet the lamp-type searching instruction and whether the value from the counting unit 124 is greater than the amount value predetermined by the parameter predetermining module 11. When the answer from the LED chip is match with the lamp-type searching instruction, the following adding module 13 adds the matched LED chip into the controlling system 100. The counting unit 124 is configured for adding 1 to the current value when the value therefrom is less than the amount value predetermined by the parameter predetermining module 11. Understandably, the searching module 12 can be assembled into the user interface and designed into an interactive command. After the user sets up the parameter predetermining module 11, the searching module 12 can be turned on or not on the basis of user's mind.

The adding module 13 is configured for adding the searched LED chips into the controlling system 100 and assigning distinguishable parameter to the added LED chips so as that the following system configuration module 14 addresses and controls the added LED chips to work in a certain work mode. The adding module 13 modifies the added LED chips parameter settings and assigns the added LED chips new address value and new type value so as to distinguish from other LED chips. The following system configuration module 14 can find the added LED chips according to the new address value and new type value. The adding module 13 may run in the background of the client and not interact with user.

The system configuration module 14 is configured for setting controlling mode for the added LED chips of the adding module 13. The controlling mode may include one or more of an one-key off mode, an X %-brightness on mode, and a color-temperature scene control mode. The color-temperature scene control mode includes one or two of a cool control mode and a warm color control mode. In the present embodiment, the system configuration module 14 includes the one-key off mode 141, the X %-brightness on mode 142, and the color-temperature scene control mode 143. In fact, the above control mode may be disposed onto the interface of the client in forms of button.

The one-key off mode 141 includes an off initializing unit 1411, an off judging unit 1412, an off-instruction transmitting unit 1413, and an off counting unit 1414. The off initializing unit 1411 is configured for assigning 0 to the first LED chip detected by the controlling system 100. The off judging unit 1412 is configured for judging whether the value from the off counting unit 1414 is greater than the amount value predetermined by the parameter predetermining module 11. The off-instruction transmitting unit 1413 is configured for transmitting an off instruction to all of the LED chips which is electrically connected to the controlling system 100 when the value from the off counting 1414 is less that the amount value predetermining by the parameter predetermining module 11. The off counting unit 1414 is configured for adding 1 to the current value when the value therefrom is less than the amount value predetermined by the parameter predetermined module 11. When the off-instruction transmitting unit 1413 transmits the off instruction to one LED chip, the LED chip will be turned off by a switcher (not shown) which is controlled by a processor, such as CPU.

The X %-brightness on mode 142 includes an on initializing unit 1421, a RGB-typed LED judging unit 1422, an on judging unit 1423, an on-instruction transmitting unit 1424, and an on counting unit 1425. The on initializing unit 1421 is configured for assigning 0 to the first LED chip detected by the controlling system 100. The RGB-typed LED judging unit 1422 is configured for judging whether the LED chip detected by the controlling system 100 is a RGB-typed LED chip. The on judging unit 1423 is configured for judging whether the value from the on counting unit 1425 is greater than the amount value predetermined by the parameter predetermining module 11. The on-instruction transmitting unit 1424 is configured for transmitting an on instruction of X %-brightness to the current LED chip which is electrically connected to the controlling system 100 when the value from the on counting unit 1425 is less than the amount value predetermined by the parameter predetermining module 11. The on counting unit 1425 is configured for adding 1 to the current value when the value therefrom is less than the amount value predetermined by the parameter predetermined module 11. When the on-instruction transmitting unit 1424 transmits the on instruction of X %-brightness to one LED chip, the LED chip will be turned on by the switcher and the current brightness of the LED chip is X percentage of the total brightness value thereof.

The color-temperature scene control mode 143 include a color-temperature initializing unit 1431, a double-color-typed LED judging unit 1432, a color-temperature judging unit 1433, a color-temperature instruction transmitting unit 1434, and a color-temperature counting unit 1435. The color-temperature initializing unit 1431 is configured for assigning 0 to the first LED chip detected by the controlling system 100. The double-color-typed LED judging unit 1432 is configured for judging whether the current LED chip detected by the controlling system 100 is a double-color temperature-typed LED chip 102. The color-temperature judging unit 1433 is configured for judging whether the value from the color-temperature counting unit 1435 is greater than the amount value predetermined by the parameter predetermined module 11. The color-temperature instruction transmitting unit 1434 is configured for transmitting an adjusting command of cool or warm to the current LED chip which is electrically connected to the controlling system and is the double-color-typed LED chip 103 when the value from the color-temperature counting unit 1435 is less than the amount value predetermined by the parameter predetermined module 11. The color-temperature counting unit 1435 is configured for adding 1 to the current value when the value therefrom is less than the amount value predetermined by the parameter predetermined module 11. When the color-temperature instruction transmitting unit 1434 transmits the adjusting command of cool or warm to one LED chip, the LED chip will be a cool light or a warm light.

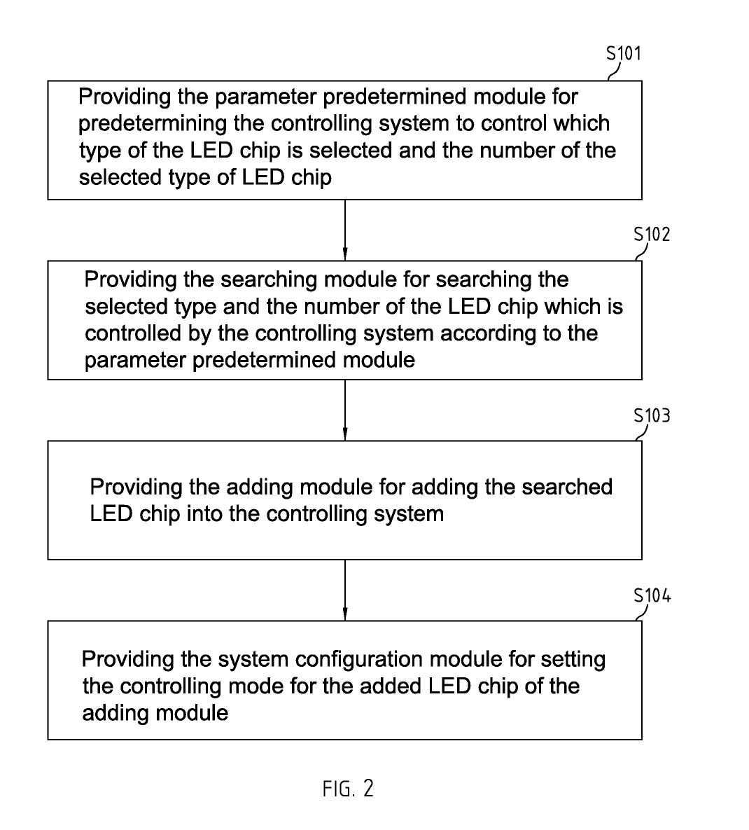

As shown in FIG. 2, a flowchart illustrating a method of controlling LED lamps using the controlling system 100 is presented. The method of controlling LED lamps using the controlling system 100 includes the following steps:

S101: providing the parameter predetermined module 11 for predetermining the controlling system 100 to control which type of the LED chip is selected and how much the selected type of LED chip has;

S102: providing the searching module 12 for searching the selected type and amount of the LED chip which is controlled by the controlling system 100 according to the parameter predetermined module 11;

S103: providing the adding module 13 for adding the searched LED chip into the controlling system 100; and

S104: providing the system configuration module 14 for setting the controlling mode for the added LED chip of the adding module 13.

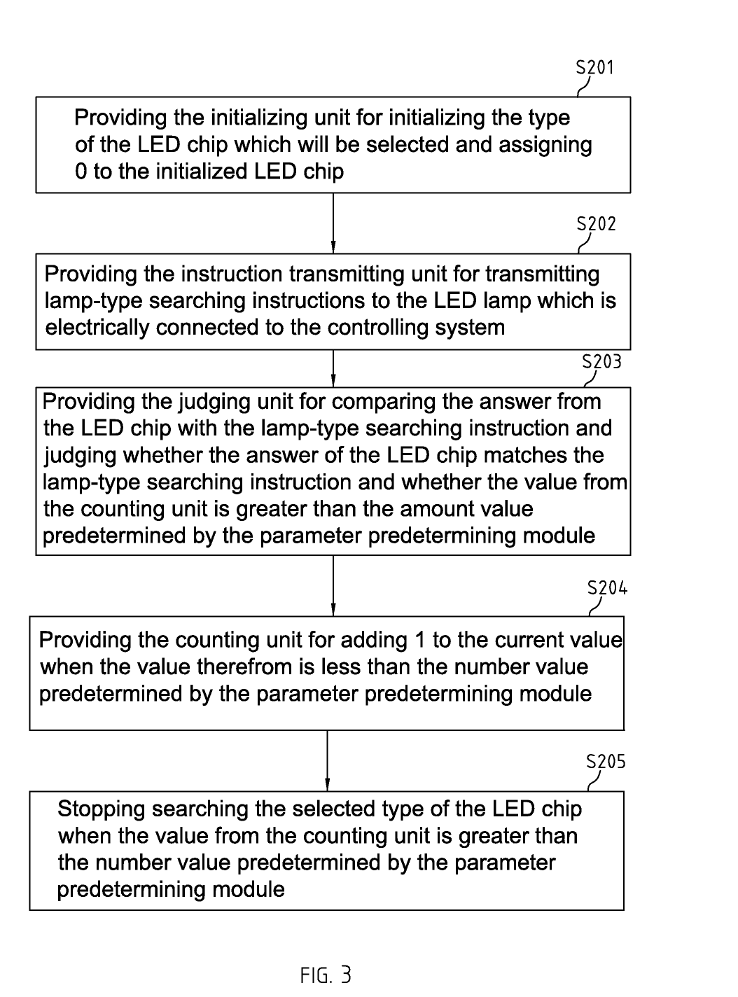

In step S102, the step S102 further includes the following steps as shown in FIG. 3:

S201: providing the initializing unit 121 for initializing the type of the LED chip which will be selected and assigning 0 to the initialized LED chip;

S202: providing the instruction transmitting unit 122 for transmitting lamp-type searching instructions to the LED lamp 10 which is electrically connected to the controlling system 100;

S203: providing the judging unit 123 for comparing the answer from the LED chip with the lamp-type searching instruction and judging whether the answer of the LED chip is meet the lamp-type searching instruction and whether the value from the counting unit 124 is greater than the amount value predetermined by the parameter predetermining module 11;

S204: providing the counting unit 124 for adding 1 to the current value when the value therefrom is less than the amount value predetermined by the parameter predetermining module 11; and

S205: stopping searching the selected type of the LED chip when the value from the counting unit 124 is greater than the amount value predetermined by the parameter predetermining module 11.

Repeating the step S201 to the step S205, all of the LED chips, which needs to be controlled by the controlling system 100, will be searched and loaded into the controlling system 100. And then, the controlling system 100 can control the LED chips to work under a certain control mode.

User can select one of the one-key off mode 141, the X %-brightness on mode 142, and the color-temperature scene control mode 143 to control the selected LED chips when user operates the selected LED chips to work via the system configuration module 14.

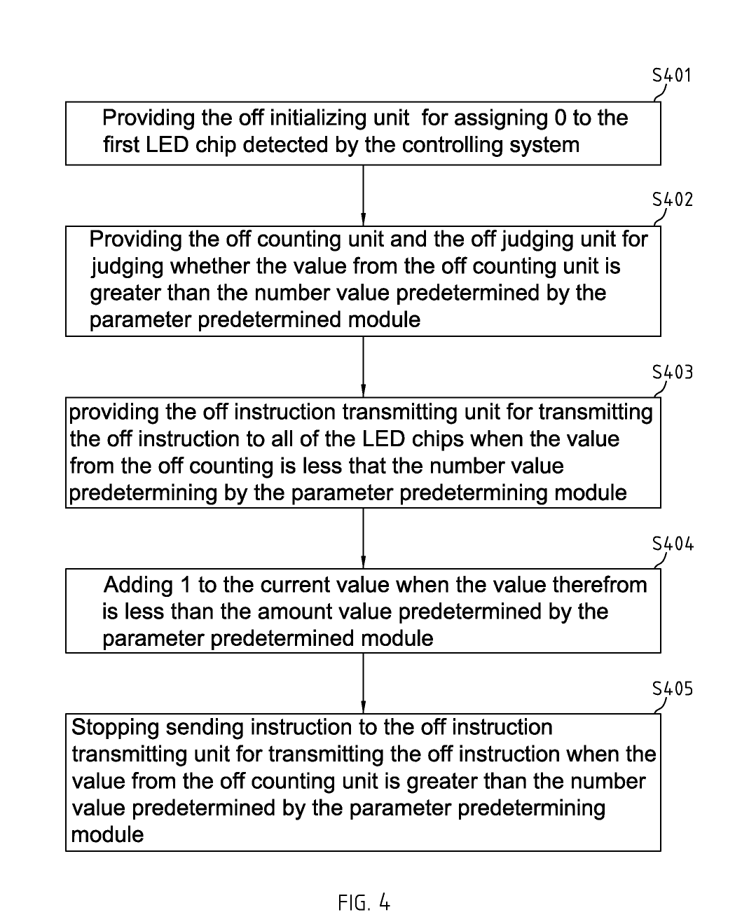

Reference to FIG. 4, a flowchart illustrating a method of controlling LED lamps using the one-key off mode 141 of the controlling system 100 is shown. The method includes the following steps:

S401: providing the off initializing unit 1411 for assigning 0 to the first LED chip detected by the controlling system 100;

S402: providing the off counting unit 1414 and the off judging unit 1412 for judging whether the value from the off counting unit 1414 is greater than the amount value predetermined by the parameter predetermined module 11;

S403: providing the off instruction transmitting unit 1413 for transmitting the off instruction to all of the LED chips when the value from the off counting 1414 is less that the amount value predetermining by the parameter predetermining module 11;

S404: adding 1 to the current value when the value therefrom is less than the amount value predetermined by the parameter predetermined module 11; and

S405: stopping sending instruction to the off instruction transmitting unit 1413 for transmitting the off instruction when the value from the off counting unit 1414 is greater than the amount value predetermined by the parameter predetermining module 11.

When the step S405 is finished, all of the LED chips controlled by the controlling system 100 are turned off. That is to say, only a button of ‘one-key off mode’ is pressed, all of the LED chips are closed.

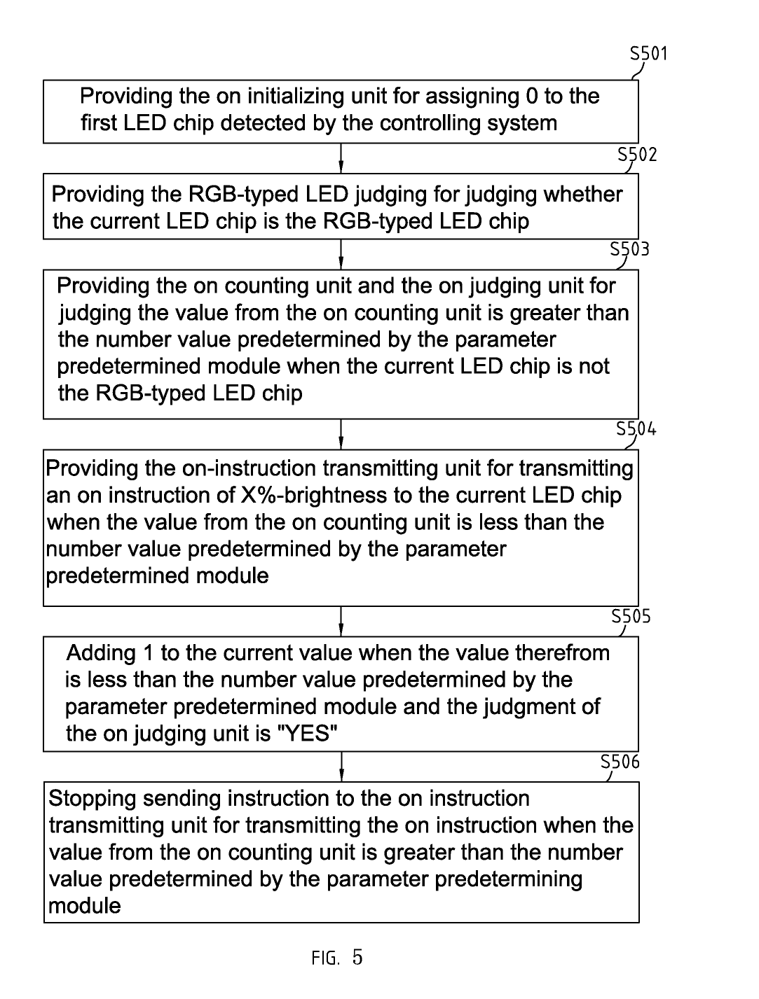

As is shown in FIG. 5, when user select a button of ‘X %-brightness on mode’, such as 50%-brightness on mode or 30%-brightness on mode, the X %-brightness on mode 142 will be executed in following steps:

S501: providing the on initializing unit 1421 for assigning 0 to the first LED chip detected by the controlling system 100;

S502: providing the RGB-typed LED judging 1422 for judging whether the current LED chip is the RGB-typed LED chip 103;

S503: providing the on counting unit 1425 and the on judging unit 1423 for judging the value from the on counting unit 1425 is greater than the amount value predetermined by the parameter predetermined module 11 when the current LED chip is not the RGB-typed LED chip 103;

S504: providing the on-instruction transmitting unit 1424 for transmitting an on instruction of X %-brightness to the current LED chip when the value from the on counting unit 1425 is less than the amount value predetermined by the parameter predetermined module 11;

S505: adding 1 to the current value when the value therefrom is less than the amount value predetermined by the parameter predetermined module 11 and the judgment of the on judging unit 1423 is “YES”; and

S506: stopping sending instruction to the on instruction transmitting unit 1424 for transmitting the on instruction when the value from the on counting unit 1425 is greater than the amount value predetermined by the parameter predetermining module 11.

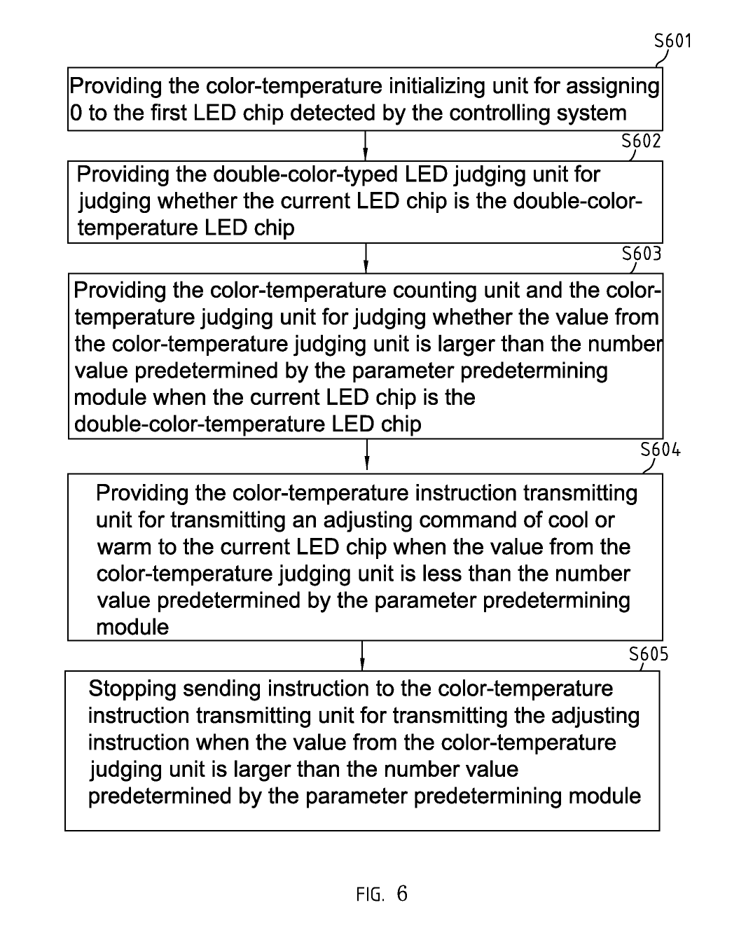

Referring to FIG. 6, when user selects a button of ‘cool’ or a button of ‘warm’ of the color-temperature scene control mode 143, the color-temperature scene control mode 143 will be executed in following steps:

S601: providing the color-temperature initializing unit 1431 for assigning 0 to the first LED chip detected by the controlling system 100;

S602: providing the double-color-typed LED judging unit 1432 for judging whether the current LED chip is the double-color-temperature LED chip 102;

S603: providing the color-temperature counting unit 1435 and the color-temperature judging unit 1433 for judging whether the value from the color-temperature judging unit 1433 is larger than the amount value predetermined by the parameter predetermining module 11 when the current LED chip is the double-color-temperature LED chip 102;

S604: providing the color-temperature instruction transmitting unit 1434 for transmitting an adjusting command of cool or warm to the current LED chip when the value from the color-temperature judging unit 1433 is less than the amount value predetermined by the parameter predetermining module 11; and

S605: stopping sending instruction to the color-temperature instruction transmitting unit 1424 for transmitting the adjusting instruction when the value from the color-temperature judging unit 1433 is larger than the amount value predetermined by the parameter predetermining module 11.

As described above, user can control all of the LED chip via the controlling system 100.

In use, the controlling system 100 for LED lamps hides most operation which is executed in background of client and provides some simple button for user via the above function module and method, which overcomes the professional and complicated interface of the art.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A controlling system for LED lamps which comprises one or more of at least one single-color-temperature-typed LED chip, at least one double-color-temperature-typed LED chip, and at least one RGB-typed LED chip, the controlling system comprising:
a parameter predetermining module configured for predetermining the controlling system to control which type of the LED chip is selected and how much the selected type of LED chip has;
a searching module configured for searching the selected type and amount of the LED chip which is controlled by the controlling system according to the parameter predetermining module;
an adding module configured for adding the searched LED chip into the controlling system; and
a system configuration module configured for setting the controlling mode for the added LED chip of the adding module.

2. The controlling system for LED lamps of claim 1, wherein the searching module comprises an initializing unit, an instruction transmitting unit, a judging unit, and a counting unit, the initializing unit is configured for initializing the type of LED chip which will be searched and assigning 0 to the initialized LED chip, the instruction transmitting unit is configured for transmitting lamp-type searching instructions to the LED lamp which is electrically connected to the controlling system, the judging unit is configured for comparing the answer of the LED chip with the lamp-type searching instruction and judging whether the answer of the LED chip is meet the lamp-type searching instruction and whether the value from the counting unit is greater than the amount value predetermined by the parameter predetermining module, the counting unit is configured for adding 1 to the current value when the value therefrom is less than the amount value predetermined by the parameter predetermining module.

3. The controlling system for LED lamps of claim 1, wherein the controlling mode set by the system configuration module comprises one or more of an one-key off mode, an X %-brightness on mode, and a color-temperature scene control mode.

4. The controlling system for LED lamps of claim 3, wherein the one-key off mode comprises an off initializing unit, an off judging unit, an off-instruction transmitting unit, and an off counting unit, the off initializing unit is configured for assigning 0 to the first LED chip detected by the controlling system, the off judging unit is configured for judging whether the value from the off counting unit is greater than the amount value predetermined by the parameter predetermining module, the off-instruction transmitting unit is configured for transmitting an off instruction to all of LED chip which is electrically connected to the controlling system when the value from the off counting unit is less than the amount value predetermined by the parameter predetermining module, the off counting unit is configured for adding 1 to the current value when the value therefrom is less than the amount value predetermined by the parameter predetermining module.

5. The controlling system for LED lamps of claim 3, wherein the X of the X %-brightness on mode varies from 0 to 100.

6. The controlling system for LED lamps of claim 3, wherein the X %-brightness on mode comprises an on initializing unit, a RGB-typed LED judging unit, an on judging unit, an on-instruction transmitting unit, and an on counting unit, the on initializing unit is configured for assigning 0 to the first LED chip detected by the controlling system, the RGB-typed LED judging unit is configured for judging whether the LED chip detected by the controlling system is RGB-typed LED chip, the on judging unit is configured for judging whether the value from the on counting unit is greater than the amount value predetermined by the parameter predetermining module, the on-instruction transmitting unit is configured for transmitting an on instruction of X %-brightness to the current LED chip which is electrically connected to the controlling system when the value from the on counting unit is less than the amount value predetermined by the parameter predetermining module, the on counting unit is configured for adding 1 to the current value when the value therefrom is less than the amount value predetermined by the parameter predetermining module.

7. The controlling system for LED lamps of claim 3, wherein the color-temperature scene control mode comprises one or two of a cool color control mode and a warm color control mode.

8. The controlling system for LED lamps of claim 3, wherein the color-temperature scene control mode comprises a color-temperature initializing unit, a double-color-typed LED judging unit, a color-temperature judging unit, a color-temperature instruction transmitting unit, and a color-temperature counting unit, the color-temperature initializing unit is configured for assigning 0 to the first LED chip detected by the controlling system, the double-color-typed LED judging unit is configured for judging whether the current LED chip detected by the controlling system is the double-color-temperature-typed LED chip, the double-color-temperature judging unit is configured for judging whether the value from the color-temperature counting unit is greater than the amount value predetermined by the parameter predetermining module, the color-temperature instruction transmitting unit is configured for transmitting an adjustment command of X %-brightness to the current LED chip which is electrically connected to the controlling system when the value from the color-temperature counting unit is less than the amount value predetermined by the parameter predetermining module, the color-temperature counting unit is configured for adding 1 to the current value when the value therefrom is less than the amount value predetermined by the parameter predetermining module.

9. The controlling system for LED lamps of claim 1, wherein the controlling system communicate with the one or more of at least a single-color-temperature-typed LED chip, at least a double-color-temperature-typed LED chip, and at least a RGB-typed LED chip via Bluetooth or WIFI.

10. The controlling system for LED lamps of claim 1, wherein each of the LED chips of the LED lamp comprises a signal generator and receiver.
